(19) United States
(12) Patent Application Publication
(10) Pub. No.: US 2006/0087391 A1
(43) Pub. Date: Apr. 27, 2006

(54) Electromagnetic docking apparatus

(76) Inventor: Glenn J. Ferro, Newton, NH (US)

Correspondence Address: BROMBERG & SUNSTEIN LLP, 125 SUMMER STREET, BOSTON, MA, 02110-1618, US

(21) Appl. No.: 11/259,734

(22) Filed: Oct. 26, 2005

Related U.S. Application Data
(60) Provisional application No. 60/622,311, filed on Oct. 26, 2004.

(51) Int. Cl. H01F 13/00

(52) U.S. Cl. 335/284

(57) ABSTRACT

This invention facilitates docking between a vessel, such as a boat or helicopter, which is mounted with an electromagnet, and a fixed platform, such as a dock, trailer, or landing platform, which is mounted with a ferromagnetic metal that is attracted to an energized electromagnet. The invention also facilitates docking between a vessel mounted with a ferromagnetic material and a fixed platform mounted with an electromagnet.

### PRIORITY

This patent application claims priority from provisional U.S. patent application No. 60/622,311, filed Oct. 26, 2004, entitled “ELECTROMAGNETIC DOCKING APPARATUS,” and naming Glenn J. Ferro as inventor, the disclosure of which is incorporated in this application, in its entirety, by reference.

### FIELD OF THE INVENTION

The present invention relates generally to vessel docking, and more particularly to the use of electromagnets to facilitate docking of moving vehicles, such as, but not limited to, boats, aircraft, and trailers.

### SUMMARY OF THE INVENTION

The present invention contemplates, according to one embodiment, a system for docking a floating vessel comprising an electromagnet mounted to the vessel, a power supply in the vessel for providing current to the electromagnet, an actuator for controlling the current to the electromagnet, and a ferromagnetic material mounted on adjustable mounting means affixed to a docking site. “Ferromagnetic,” as used here, means a material that is attracted to a magnet or an energized electromagnet. When the electromagnet is proximate to the ferromagnetic material and when the actuator permits current to flow through the electromagnet, the electromagnet is attracted to the ferromagnetic material and draws the vessel towards the docking site.

Alternatively, the invention contemplates a system for docking a floating vessel comprising an electromagnet mounted on a docking site, a power supply on the docking site for providing a current to the electromagnet, an actuator for controlling the current to the electromagnet, and a ferromagnetic material mounted to the floating vessel. When the electromagnet is proximate to the ferromagnetic material and when the actuator permits the current to flow through the electromagnet, the ferromagnetic material on the vessel is attracted to the electromagnet on the docking site.

According to another embodiment, the invention contemplates a system for securing a vessel comprising an electromagnet mounted on a docking site, a power supply on the docking site for providing a current to the electromagnet, an actuator for controlling the current to the electromagnet, a ferromagnetic material mounted to the vessel, and a remote device for activating the actuator. The remote device can activate the actuator so that current flows to the electromagnet; therefore, when the ferromagnetic material is proximate to the electromagnet, the electromagnet will attract the ferromagnetic material and draw the vessel towards the docking site.

Another embodiment of the invention contemplates a system for attaching a vessel to a trailer comprising an electromagnet mounted to the trailer, a power supply on the trailer for providing a current to the electromagnet, an actuator for controlling the current to the electromagnet, and a ferromagnetic material mounted to the vessel. When the electromagnet is proximate to the ferromagnetic material and when the actuator permits the current to flow through the electromagnet, the ferromagnetic material on the vessel is attracted to the electromagnet.

According to another embodiment, the invention contemplates a system for attaching a vessel to a trailer, comprising an electromagnet mounted on a vessel, a power supply on the vessel for providing a current to the electromagnet, an actuator for controlling the current to the electromagnet, and a ferromagnetic material mounted on the trailer. When the electromagnet is proximate to the ferromagnetic material and when the actuator permits the current to flow through the electromagnet, the electromagnet on the vessel attracts the ferromagnetic material on the trailer.

Another embodiment of the invention contemplates a system for attaching a tugboat to a floating vessel comprising an electromagnet mounted on a tugboat, a power supply on the tugboat for providing a current to the electromagnet, an actuator for controlling the current to the electromagnet, and a ferromagnetic material incorporated into the vessel. When the electromagnet is proximate to the ferromagnetic material and when the actuator permits the current to flow through the electromagnet, the electromagnet on the tugboat attracts the ferromagnetic material on the vessel.

An additional embodiment contemplates a system for mooring a floating vessel to a buoy comprising an electromagnet mounted on the vessel, a power supply in the vessel for providing a current to the electromagnet, an actuator for controlling the current to the electromagnet, a ferromagnetic material mounted on the buoy, and an arm guide mounted on the buoy for guiding the floating vessel. When the electromagnet is proximate to the ferromagnetic material and when the actuator permits the current to flow through the electromagnet, the electromagnet on the vessel attracts the ferromagnetic material on the buoy and the arm guide directs the vessel as it approaches the buoy.

The invention also contemplates a system for mooring a floating vessel to a buoy comprising an electromagnet mounted on an adjustable means capable of being affixed to the vessel, a portable power supply for providing a current to the electromagnet, an actuator for controlling the current to the electromagnet, a ferromagnetic material mounted on the buoy, and an arm guide mounted on the buoy for guiding the floating vessel. When the electromagnet is proximate to the ferromagnetic material and when the actuator permits the current to flow through the electromagnet, the ferromagnetic material on the buoy is attracted to the electromagnet on the means and the arm guide directs the vessel as it approaches the buoy.

Another embodiment contemplates a system for docking a flying vehicle to an aircraft carrier comprising an electromagnet mounted on the aircraft carrier, a power supply in the aircraft carrier for providing a current to the electromagnet, an actuator for controlling the current to the electromagnet, and a ferromagnetic material mounted on the flying vehicle. When the electromagnet is proximate to the ferromagnetic material and when the actuator permits the current to flow through the electromagnet, the ferromagnetic material on the flying vehicle is attracted to the electromagnet on the aircraft carrier.

The invention also contemplates a system for docking a flying vehicle to an aircraft carrier comprising an electromagnet mounted on the flying vehicle, a power supply in the flying vehicle for providing a current to the electromagnet, an actuator for controlling the current to the electromagnet, and a ferromagnetic material mounted on the aircraft carrier. When the electromagnet is proximate to the ferromagnetic material and when the actuator permits the current to flow through the electromagnet, the electromagnet on the flying vehicle attracts and is pulled towards the ferromagnetic material on the aircraft carrier.

### BRIEF DESCRIPTION OF THE DRAWINGS

The foregoing features of the invention will be appreciated more fully from the following further description thereof with reference to the accompanying drawings wherein:

FIG. 1 is a perspective view of one embodiment of the invention.

FIG. 2 is a perspective view of another embodiment of the invention.

FIG. 3 is a perspective view of an internal bow-mounted electromagnet and matching support hardware.

FIG. 4 is a perspective view of a boat equipped with multiple electromagnets and matching docking hardware.

FIG. 5 is a side view of a boat equipped with a V-shaped electromagnet, side-mounted electromagnet, and hull-mounted electromagnet.

FIG. 6 is a side view of an electromagnet system configuration.

FIG. 7 is a side view of another embodiment of the invention.

FIG. 8 is a plan view of a trailer equipped with electromagnets.

FIG. 9 is a side view of a boat equipped with a hull-mounted electromagnet and a buoy equipped with an arm guide and hardware that matches the electromagnet.

FIG. 10 is two perspective views of the electromagnet cleat clamp system.

### DESCRIPTION OF SPECIFIC EMBODIMENTS

The present invention is composed of metal, plastic, and electronic elements, including electromagnets. The term electromagnet refers to devices created from metal and electrical components. These electronic magnets could take many shapes, such as small rectangular magnets, large rectangular magnets, or V-shaped magnets. These magnets could be designed for installation on, for example, the port or starboard sides of a vessel, the bow or stern of a vessel, or the cleats on the deck of a vessel. The magnets could be attached to bolts, screws, and mounting plates and could be wired to a plastic or metal on/off switch and a 12-volt connector to an electrical system. The switch could be connected to a suction cup so that it could be mounted on any surface of the vessel. The switch could also be permanently mounted to a surface of the vessel. These electromagnets would work in conjunction with ferromagnetic plates attached to adjustable mounting devices constructed from material such as, but not limited to, fiberglass. These mounting devices could be adjustable, with dimensions ranging from 36 to 48 inches in length and 2 or more inches in diameter, and could be affixed to the vessel's docking site.

The plastic components of the invention could be formed using plastic molding techniques such as injection or blow molding. Injection molding requires that melted plastic be forcefully injected into relatively cool molds, so that the plastic, as it cools, takes on the shape of the mold cavity and requires few postmolding operations when fully cooled. Blow molding is a form of extrusion, where a molten tube is pushed into a bottle-shaped mold. Compressed air then forces the molten tube against the cold walls of the mold. Molds are generally side-fed, with the thickness controlled by a tapered core or variable-orifice die. Continuous extrusion of the plastic is possible through the use of multiple blow molds.

The term vessel is used to refer to, but is not limited to, boats, automobiles, trucks, planes, motorcycles, trains, off-road vehicles, and/or space vehicles. It may also refer to non-vehicles that must be secured to prevent motion, and may be used in many additional configurations. The embodiments of the invention described herein may be installed during construction of the vessel, or may be retrofitted to existing vessels.

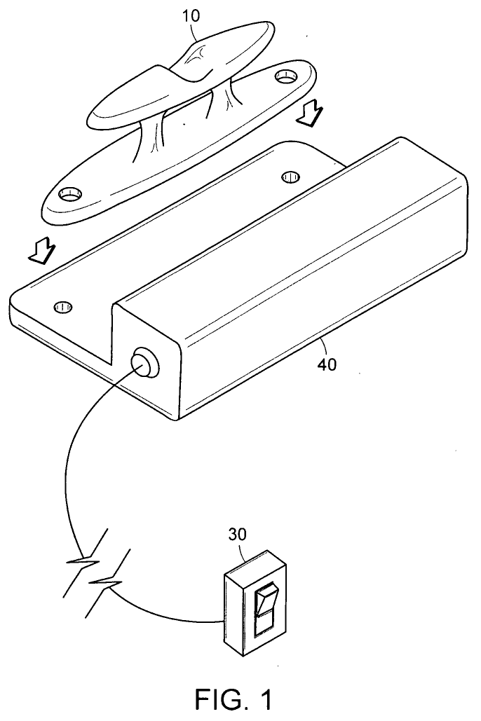

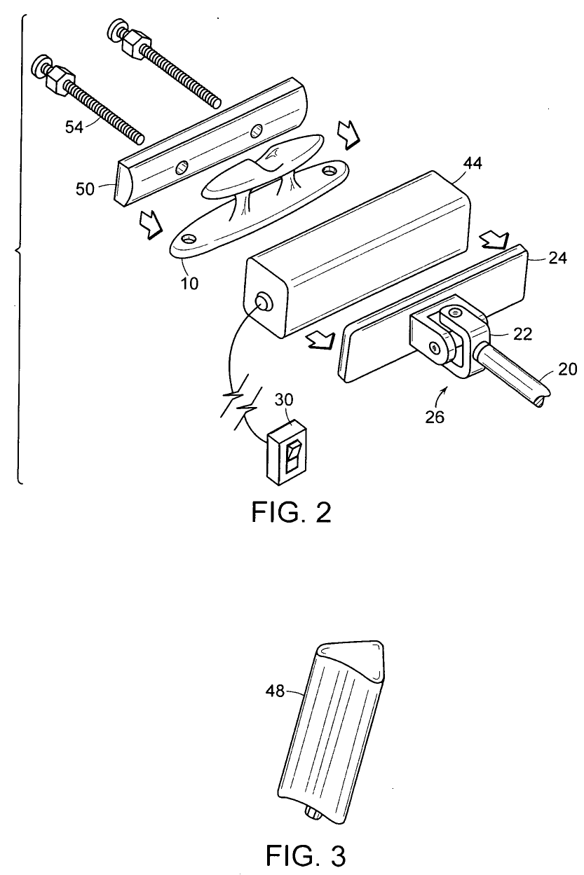

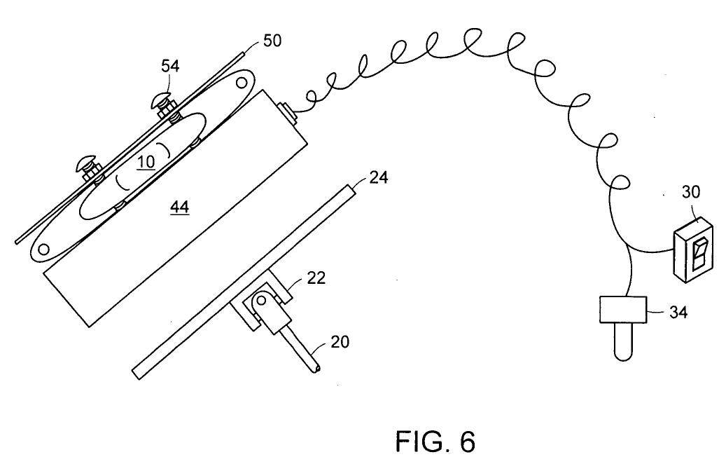

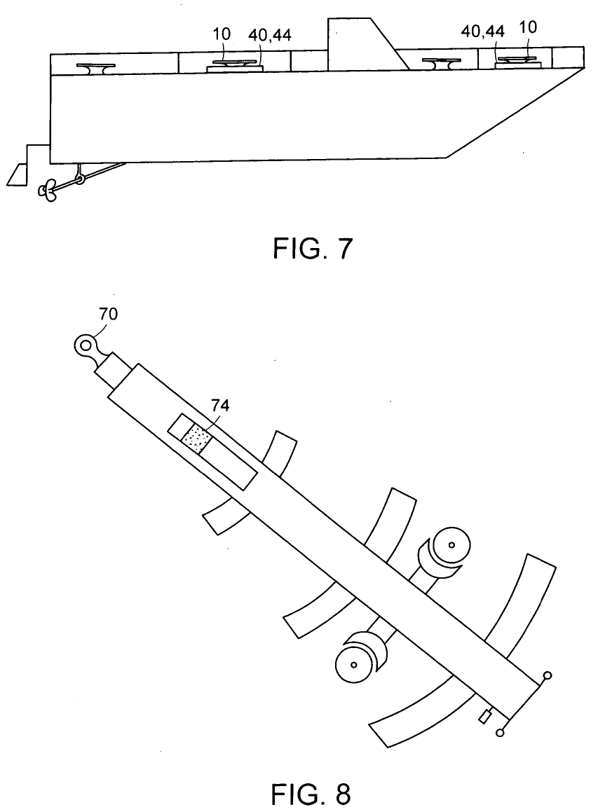

FIG. 1 shows one specific embodiment including a side-mounted electromagnet 40 that bolts 54 under a cleat 10 and is controlled by a switch 30. FIG. 2 shows an alternative side-mounted electromagnet 44, which bolts 54 to the side of a cleat 10 and a docking support 20 with matching hardware 24 for the electromagnet 44. The docking support(s) 20 can be fixed or adjustable, and may contain a movable joint 22. FIG. 7 shows a boat with electromagnets 40, 44 connected to its cleats 10 with hardware. Finally, FIG. 10 shows a side-mounted electromagnet 44 that bolts 54 to the side of a cleat 10 and is switched on or off with a switch 30. In each of these Figures, electromagnets 40, 44 are connected with hardware 54 to the cleats 10 of a boat. When switched on using, for example, a 12-volt plug 34 or hardwiring, an electromagnetic field generated by the electromagnets 40, 44 pulls the boat cleats 10 towards (passive) dockside hardware 26, shown in FIGS. 2, 4, and 6, which may include mounting devices 20 and a ferromagnetic plate 24 such as steel.

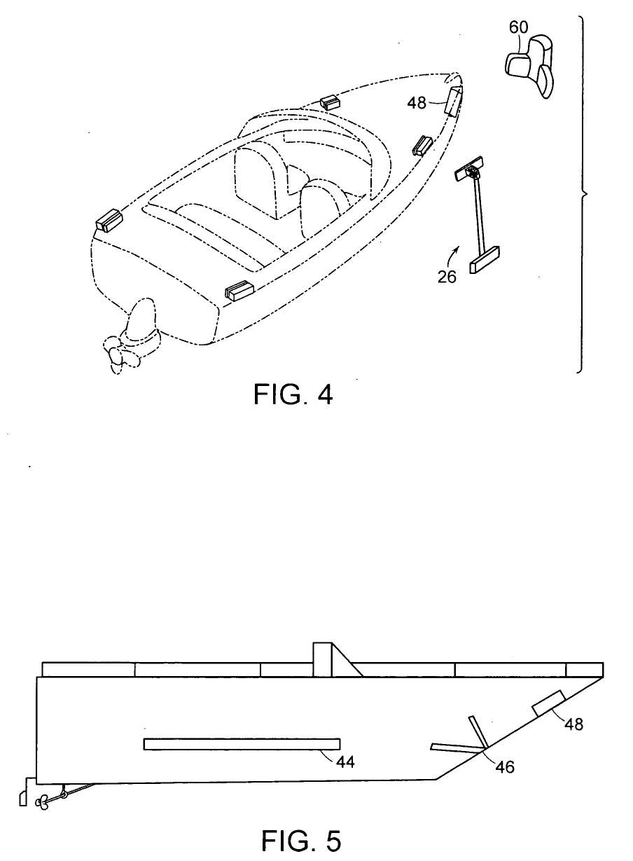

In another specific embodiment, electromagnets are built into the design of the boat. The system described in FIG. 3 has an electromagnet 48 on the bow (front) of the vessel, built in or bolted on, and matching support hardware. The support hardware can be mounted on a dock, trailer or other structure. The system shown in FIG. 5 has a V-shaped magnet 46 that may be built in or bolted on to the bow (front) of the vessel. The side-mounted electro-magnets 44 are internal, built-in, or external to the side of the vessel. There will be matching support hardware. The system is not limited to these embodiments, however; a V-shaped electromagnet 46, 48, shown in FIGS. 3, 4, and 5, could be placed in the bow of the boat, with corresponding V-shaped docking hardware 60 installed on the dock, as shown in FIG. 4. This installation can be located above or below the water line. When the power source on the boat is activated by a switch 30, this configuration would practically allow “self-docking,” as the boat would be pulled towards and locked into the V-shaped dockside hardware 60 by the attached electromagnets 46, 48.

The invention described herein may also be configured so that the electromagnet is secured on the dock and activated using a remote such as, but not limited to, a sensor switch, garage door opener, key fob, or similar device. The passive ferromagnetic hardware could be located on the vessel itself, and a passenger in the vessel could activate the electromagnet using a remote device. This design would permit the use of a larger electromagnet, which requires more power but would be capable of docking larger, heavier vessels with ferromagnetic attachments and steel ships or submarines, whose ferromagnetic hulls would make installation of passive hardware unnecessary.

An embodiment of this invention could include placement of an electromagnet, which may be V-shaped, on or in the design of the boat, with matching ferromagnetic hardware 70, 74, which may steel plates, on a boat trailer, as shown in FIG. 8. This configuration could be reversed, with the passive hardware on or in the design of the boat and the electromagnet installed on the trailer. This will ensure fast, efficient loading of a boat onto a trailer. The invention, in its above-mentioned conformations, could also be used to facilitate engagement between a vehicle, such as a tractor trailer, and a trailer hitch. When backing a trailer containing an electromagnet onto a trailer hitch, the electromagnet would help position the trailer for proper engagement with the trailer hitch. This configuration could be reversed, with an electromagnet on a trailer hitch and the passive ferromagnetic hardware on the vehicle.

A further embodiment of the present invention could involve placement of one or several electromagnets, which may be composed of metal and electrical components, on or in the design of a tugboat, with matching passive ferromagnetic hardware, which may be steel plates, on large vessels that require tugboat assistance. Placement of electromagnets on a tugboat would also permit the tugboat to engage with steel vessels, whose ferromagnetic hulls would make installation of passive hardware unnecessary. The electromagnets in these embodiments could be capable of using 12 or 24 volt DC, or 120 or 240 volt AC. The electromagnets in these embodiments could also be V-shaped.

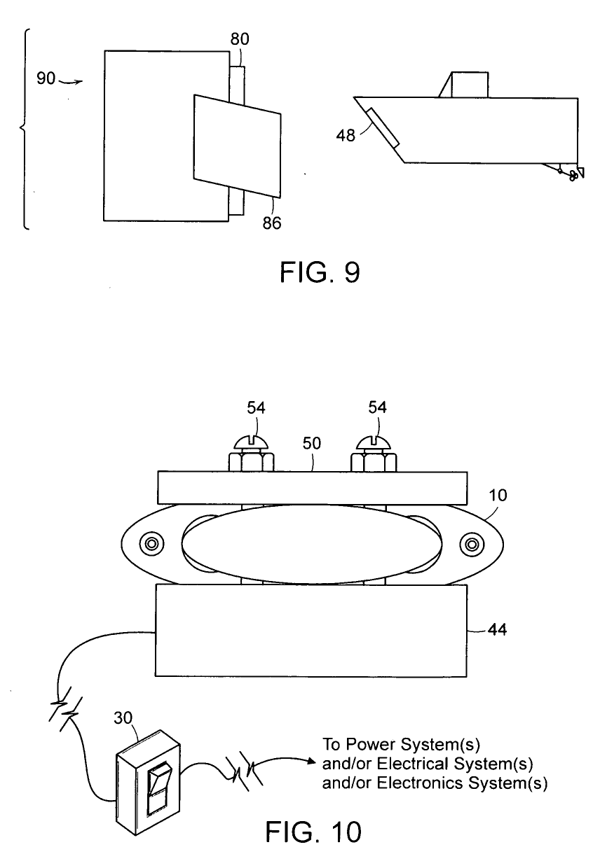

A buoy mooring version could include, but is not limited to, a boat with an electromagnet 48 and a buoy 90 with matching passive ferromagnetic hardware 80, as shown in FIG. 9. This would increase the ease with which a boat could moor with a buoy 90, especially if the boat is manned by a single occupant. The buoy 90 could have wedge-shaped hardware 80 to accommodate a boat's V-shaped electromagnet 48. The buoy 90 may also include an arm guide 96, which could correctly position the boat and facilitate engagement between the electromagnet 48 and the passive hardware 80 shown in FIG. 9. A manual version of this system could include an electromagnet attached to the end of an adjustable arm with matching hardware on the buoy 90, such that the occupant of a boat could extend the device to connect with the buoy 90 or buoy line and easily moor the boat. The electromagnet 48 in these embodiments could be composed of metal and electrical components, and could be capable of using 12 or 24 volt DC, or 120 or 240 volt AC. The electromagnet 48 in these embodiments could also be V-shaped. The ferromagnetic material in these embodiments could be composed of steel plates.

The invention may also be used to release and secure aircraft. For example, an electromagnet placed on an aircraft carrier could be used to guide ferromagnetic hardware-equipped aircraft, such as airplanes, helicopters, or dirigibles, to their landing locations. As the aircraft lands, the electromagnet would draw the aircraft to the deck, bringing it to a complete stop and eliminating the need for catch wires. The electromagnet could also be placed on the aircraft, and could be controlled by the pilot as he or she attempts to land. This system could be adapted for ground-based landings, allowing for shorter runways that can still accommodate large aircraft. This would be useful both for military and commercial airports. Alternatively, the invention can be used to ensure accurate time release of aircraft preparing to become airborne. The electromagnet could replace the hook on an aircraft carrier catapult, such that an aircraft speeding towards the end of its runway could be released when it reaches the correct position on the runway. The electromagnet in these embodiments could be composed of metal and electrical components, and could be capable of using 12 or 24 volt DC, or 120 or 240 volt AC. The ferromagnetic material in these embodiments could be composed of steel plates.

Helicopters could also use the present invention to increase landing accuracy and hence landing safety. The electromagnet could either be installed on the landing pad or on the helicopter itself; both configurations would facilitate landing and increase safety by pulling the helicopter toward the desired landing point. A portable landing pad could be designed for mobile landing sites. This system could be particularly useful on aircraft carriers or similar vessels, the motion of which increases landing difficulty and poses threats to safety.

In all of the above-mentioned embodiments, electronics and sensors could be used to control the functioning of the electromagnets. These sensing technologies include capacitors, automatic sensor switches, and remotes that employ, for example, radar, sonar, or extremely-low frequency (ELF).

The invention has been described with respect to particular embodiments thereof, and it will be understood that numerous modifications are possible within the scope of the invention. For example, these systems may employ different types of switches 30 that will allow the electro-magnet to be turned on and off as needed. These systems can have the electromagnets on the vessel or on the structure. The docking support(s) 20 can be fixed or adjustable.

What is claimed is:

1. A system for docking a floating vessel comprising:
an electromagnet mounted on the vessel;
a power supply in the vessel for providing a current to the electromagnet;
an actuator for controlling the current to the electromagnet; and
a ferromagnetic material mounted on adjustable mounting means;
wherein the electromagnet is mounted on the vessel so as to interact with the ferromagnetic material as the vessel approaches the mounting means, which are affixed to a docking site, so that, when the electromagnet is proximate to the ferromagnetic material and when the actuator permits current to flow through the electromagnet, the electromagnet is attracted to the ferromagnetic material.

2. A system for docking a floating vessel according to claim 1, wherein the electromagnet is composed of metal and electrical components.

3. A system for docking a floating vessel according to claim 1, wherein the electromagnet is capable of using 12 or 24 volt DC, or 120 or 240 volt AC.

4. A system for docking a floating vessel according to claim 1, wherein the electromagnet is V-shaped.

5. A system for docking a floating vessel according to claim 1, wherein the ferromagnetic material mounted on the adjustable mounting means is composed of steel plates.

6. A system for docking a floating vessel comprising:
an electromagnet mounted on a docking site;
a power supply on the docking site for providing a current to the electromagnet;
an actuator for controlling the current to the electromagnet; and
a ferromagnetic material mounted to the floating vessel;
wherein the electromagnet is mounted to the docking site so as to interact with the ferromagnetic material as the vessel approaches the docking site, so that, when the electromagnet is proximate to the ferromagnetic material and when the actuator permits the current to flow through the electromagnet, the ferromagnetic material on the vessel is attracted to the electromagnet on the docking site.

7. A system for docking a floating vessel according to claim 6, wherein the electromagnet is composed of metal and electrical components.

8. A system for docking a floating vessel according to claim 6, wherein the electromagnet is capable of using 12 or 24 volt DC, or 120 or 240 volt AC.

9. A system for docking a floating vessel according to claim 6, wherein the ferromagnetic material mounted on the vessel is composed of steel plates.

10. A system for docking a floating vessel according to claim 6, wherein the electromagnet is V-shaped.

11. A system for securing a vessel comprising:
an electromagnet mounted on a docking site;
a power supply on the docking site for providing a current to the electromagnet;
an actuator for controlling the current to the electromagnet;
a ferromagnetic material mounted to the vessel; and
a remote device for activating the actuator;
wherein the remote device activates the actuator so that the current flows to the electromagnet so that, when the ferromagnetic material is proximate to the electromagnet, the ferromagnetic material is attracted to the electromagnet and draws the vessel towards the docking site.

12. A system for securing a vessel according to claim 11, wherein the remote device is a sensor switch or similar device.

13. A system for attaching a vessel to a trailer comprising:
an electromagnet mounted on the trailer;
a power supply on the trailer for providing a current to the electromagnet;
an actuator for controlling the current to the electromagnet; and
a ferromagnetic material mounted to the vessel;
wherein the electromagnet is mounted to the trailer so as to interact with the ferromagnetic material as the vessel approaches the trailer, so that, when the electromagnet is proximate to the ferromagnetic material and when the actuator permits the current to flow through the electromagnet, the ferromagnetic material on the vessel is attracted to the electromagnet on the trailer.

14. A system for attaching a vessel to a trailer according to claim 13, wherein the electromagnet is composed of metal and electrical components.

15. A system for attaching a vessel to a trailer according to claim 13, wherein the electromagnet is capable of using 12 or 24 volt DC, or 120 or 240 volt AC.

16. A system for attaching a vessel to a trailer according to claim 13, wherein the electromagnet is V-shaped.

17. A system for attaching a vessel to a trailer according to claim 13, wherein the ferromagnetic material mounted on the vessel is composed of steel plates.

18. A system for attaching a vessel to a trailer comprising:
an electromagnet mounted on the vessel;
a power supply on the vessel for providing a current to the electromagnet;
an actuator for controlling the current to the electromagnet; and
a ferromagnetic material mounted to the trailer;
wherein the electromagnet is mounted to the vessel so as to interact with the ferromagnetic material as the vessel approaches the trailer, so that, when the electromagnet is proximate to the ferromagnetic material and when the actuator permits the current to flow through the electromagnet, the electromagnet on the vessel attracts the ferromagnetic material on the trailer.

19. A system for attaching a vessel to a trailer according to claim 18, wherein the electromagnet is composed of metal and electrical components.

20. A system for attaching a vessel to a trailer according to claim 18, wherein the electromagnet is capable of using 12 or 24 volt DC, or 120 or 240 volt AC.

21. A system for attaching a vessel to a trailer according to claim 18, wherein the electromagnet is V-shaped.

22. A system for attaching a vessel to a trailer according to claim 18, wherein the ferromagnetic material mounted on the trailer is composed of steel plates.
